(19) United States
(12) Patent Application Publication
(10) Pub. No.: US 2020/0096217 A1
(43) Pub. Date: Mar. 26, 2020

(54) ALARM DEVICE FOR HOUSEHOLD AIR PURIFIER FILTER REPLACEMENT BASED ON PHOTORESISTOR

(71) Applicant: BEIJING UNIVERSITY OF TECHNOLOGY, BEIJING (CN)

(72) Inventors: YIWEN JIAN, Beijing (CN); Yuchen Hou, Beijing (CN); Yingying Zhang, Beijing (CN); Xu Wang, Beijing (CN); Ruimin Guo, Beijing (CN)

(21) Appl. No.: 16/572,559

(22) Filed: Sep. 16, 2019

(30) Foreign Application Priority Data
Sep. 20, 2018 (CN) 201821540419.6

(51) Int. Cl. F24F 11/39; G01N 21/59; G01N 21/27; G01N 15/06

(52) U.S. Cl. CPC F24F 11/39; G01N 21/59; G08B 21/02; G01N 15/0618; G01N 21/27

(57) ABSTRACT

Alarm device for household air purifier filter replacement based on photoresistor comprising: light transmitter, light receiver and microcontroller are successively connected, microcontroller connects with display module and alarm module respectively, wherein light transmitter emit visible light on filter side of the purifier, light receiver receives visible light from transmitter on the other side of the filter and converts illuminance signal into an electrical signal and sends it to microcontroller; microcontroller is used to receive electrical signal and output the purification force of purifier filter and output the alarm signal of filter replacement; display module is used to display filter purification force; alarm module is used to remind user to replace filter according to the alarm signal. This application can automatically prompt user to replace the filter, avoid the filter as a secondary source of pollution, and reduce the waste of filter material.

### CROSS-REFERENCE TO RELATED APPLICATION

This application claims the priority benefit of Chinese application serial No. 201821540419.6, filed on Sep. 20, 2018, which is hereby incorporated herein by reference in its entirety.

### TECHNICAL FIELD

The present disclosure relates to the field of indoor air purifier, especially to an alarm device for household air purifier filter replacement based on photoresistor.

### BACKGROUND ART

At present, China is one of the countries with the worst PM2.5 pollution in the world. Household air purifiers are widely used In order to improve indoor air quality and ensure the health of residents. The main role of household air purifiers is to remove indoor air pollutants, including particulate matter such as dust and PM2.5, and harmful gases such as formaldehyde and TVOC. It can effectively improve indoor air quality. Air purifier generally consists of high voltage circuit, secondary ion generator, fan, filter and other parts. Its core filtering function is generally realized by physical dust removal or electrostatic dust removal. Wherein physical dust removal is to achieve air purification through interception function of HEPA filter, which is relatively economical, safe and convenient. Electrostatic dusting uses high-voltage electric field to make dust particles charged and attracted by the electrode to achieve the purpose of purifying air. Compared with physical dust removal, electrostatic dust removal has a much lower market share due to its high cost, difficulty in cleaning and ozone generation. As the core part of household air purifier, HEPA filter accumulative particle purification amount, also known as filter ash amount, will continue to increase in the process of operation and use, and when the ash amount reaches a certain amount, the filter can not purify indoor air, but may cause dust and produce indoor secondary pollution. In order to prevent secondary pollution and ensure indoor air quality, it is necessary to replace the filter of household air purifier in time. For the alarm device of filter replacement of household air purifier, the existing main product is the timer, its work principle is: set operation condition according to the maximum value of cumulative purification amount of filter particles and purifier (outdoor PM2.5 concentration, CADR value of purifier and daily running time). Calculate and set the maximum running days of air purifier. When the accumulated running days of air purifier reach the set value, use a timer to alarm filter replacement. Due to the changes of PM2.5 in outdoor air in different seasons, regions and the different use conditions, the control device of countdown timer may lead to the problems of early replacement and overuse. For example, if indoor and outdoor air condition of a household is relatively good, filter of the purifier may still be in good state when alarm is changed. At this time, it is not necessary to change the filter, but also causes unnecessary material waste; if the outdoor air pollution in the area is serious, or the user uses air purifier very frequently, before alarm signal is sent out by the countdown timer, the cumulative purification amount of particles in filter has exceeded the maximum limit, which is very easy to cause dust and produce secondary pollution. The other alarm device sets color identification bar of the filter under several typical conditions, user visually compares the actual color of filter and several color states in color bar to determine whether to replace the filter. There is more uncertainty in judgment results based on the color bar and the variety of human visual conditions.

Therefore, it is more and more important to timely replace the filter of household air purifier, and it is necessary to develop new devices to give timely alarm to the replacement of household air purifier filter.

### SUMMARY

HEPA filter is the core part of household air purifier, filter material of HEPA filter is usually composed of ultrafine glass fiber, there are many small pores inside the filter material, through which air can pass, but small particles cannot pass. The adhesion of fine particles such as dust on HEPA filter will affect the light transmittance of filter which will change with the amount of ash in filter.

The purpose of the present disclosure is to provide an alarm device for filter replacement of household air purifier based on photoresistor. Spatial illuminance value of light source through filter is used to reflect the cumulative purification status of particulate matter in the filter of the air purifier, then converts illuminance signal into voltage value signal, through the change of voltage value to realize automatic detection of accumulated purification amount of filter particles of household air purifier and timely alarm of filter screen replacement. Secondary pollution is avoided and reduce the waste of filter material at the same time.

To achieve above purposes, the technical scheme adopted by the invention is as follows:

Alarm device for household air purifier filter replacement based on photoresistor comprising: light transmitter, light receiver and microcontroller are successively connected, microcontroller connects with display module and alarm module respectively, wherein light transmitter emit visible light on filter side of the purifier, light receiver receives visible light from transmitter on the other side of the filter and converts illuminance signal into an electrical signal and sends it to microcontroller; microcontroller is used to receive electrical signal and output the purification force of purifier filter and output the alarm signal of filter replacement; display module is used to display filter purification force; alarm module is used to remind user to replace filter according to the alarm signal.

For optimized planning, microcontroller adopts STM32F103 system board, which is used to receive and process the voltage value signal output by the sensor of photosensitive resistance module, and obtain the accumulated purification amount of filter particles of purifier according to the conversion of voltage value signal, alarm signal of filter replacement is sent when the filter cumulative purification amount of particles exceeds the upper limit. For optimized planning, the light transmitter uses 1 W LED with white light.

Light receiver adopts photosensitive resistor module sensor which is sensitive to visible light and converts illuminance signal inside the filter into voltage value electrical signal and sends it to microcontroller.

For optimized planning, display module uses LCD and the alarm module adopts indicator light.

The invention has the following beneficial effects: It can accurately judge the cumulative purification status of particles in filter of household air purifier, and accordingly send an alarm signal to users to replace the filter, so that the filter of household air purifier can be fully and effectively used. It ensures indoor air quality and avoids waste of filter material. In addition, it has the advantages of strong operability, low cost and the possibility of large-scale promotion.

### THE APPENDED DRAWINGS

FIG. 1 is a schematic diagram of function module of an alarm device for filter replacement of household air purifier based on photoresistor.

FIG. 2 is a structure diagram an alarm device for filter replacement of household air purifier based on photoresistor.

### THE PREFERRED EMBODIMENT

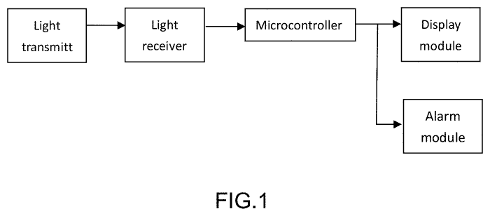

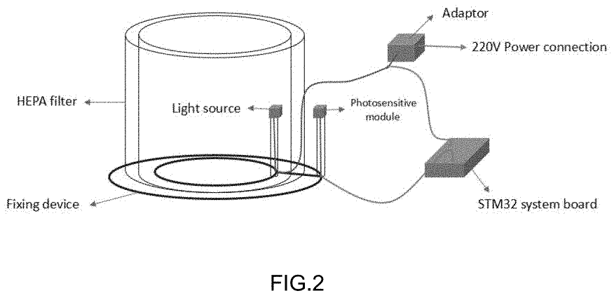

The application will be described in detail based on the attached drawings and embodiment. As shown in FIG. 1, alarm device for filter replacement of household air purifier based on photoresistor including: light transmitter, light receiver, circuit accessories, microcontroller, display module and alarm module. The light transmitter is a 1 W LED white light lamp, which emits white light outside the purifier filter; the light receiver is a photosensitive resistor module sensor sensitive to visible light, which receives white light from the outside of filter, and converts illuminance signal into voltage signal and sends it to microcontroller; microcontroller receives and processes the above information and outputs the filter purification force and the filter replacement alarm signal; display module is used to display purifier filter purification force; alarm module is used to remind the user to replace filter according to the alarm signal. Wherein microcontroller is used to receive and process the voltage value signal from photosensitive resistor module sensor, the accumulated purification amount of filter screen particles is obtained according to the signal of voltage value, when cumulative purification amount of particles in filter exceeds the upper limit of prescribed cumulative purification amount of particles, alarm signal of filter replacement will be sent. As shown in FIG. 2, the light transmitter adopts 1 W white light LED as technical light source. LED light source is a common visible light source in market. It has the characteristics of stable luminescence, high luminous efficiency, cheap price and easy access. Moreover, the luminous flux of the light source does not decrease significantly with luminescence time. Light source emits white light after the power is connected, and reaches light receiver after passing through the filter. Light receiver of the invention is a photosensitive resistor module sensor sensitive to visible light which converts illuminance signal inside filter into electric signal of voltage value. Circuit accessories include a constant voltage adapter, a dupont line, constant voltage adapter has the function of variable pressure and constant pressure, it output 5V voltage to supply power for whole circuit after 220V ac is connected, Dupont line is used to connect photosensitive resistance module sensor with microcontroller. Microcontroller adopts STM32 system board, and the detection program used for filter purifying force of purifier is solidified into its memory in advance; detection program is used to receive and process the voltage value signal from photosensitive resistor module sensor, the cumulative purification amount of filter particles of purifier is obtained from voltage value signal, and the ratio of actual cumulative purification amount of filter to the upper limit of cumulative purification amount stipulated by the national standard is the purification force, purification force is output to the display module as a percentage, when the cumulative purification amount of particles in filter exceeds the upper limit of cumulative purification amount of particles specified in the national standards of air purifiers, alarm signal of filter replacement will be sent to alarm module. In order to achieve above purposes, the filter should be calibrated in the environmental cabin before leaving the factory to determine inner illuminance value and voltage signal value of photosensitive resistance corresponding to the filter under different cumulative particle purification amount; when it is used by user after leaving the factory, filter display and alarm module of purifier can be started when the power button of air purifier is pressed, the light source is turned on and light receiver works at the same time, when cumulative purification amount of filter particles of purifier does not exceed the upper limit of cumulative purification amount stipulated by the national standards, filter purification force is displayed on electronic screen of the purifier; when accumulative purification amount of filter particles of purifier exceeds the upper limit of accumulative purification amount stipulated by national standards, an alarm signal for replacement will be sent to user.

The working process of alarm device for household air purifier filter replacement based on photoresistor is: S1, turn on the purifier and the detection circuit is started; S2, light transmitter emits visible light; S3 photoelectric signal conversion is realized by photoresistor module; S4, the microcontroller receives and processes electrical signals; S5, the ratio of actual cumulative purification amount of filter to the upper limit of cumulative purification amount specified by national standards (purification force) is output by microcontroller; S6 display the purification force of filter and send replacement alarm signal.

For photoelectric signal conversion of photosensitive module described in S3, the core component of photosensitive module is a photosensitive resistor sensitive to visible light, it also includes regulating potentiometer, triode, capacitance and resistance. The resistance of a photosensitive resistor is changed by the change of illuminance it receives, AO pin outputs voltage value at both ends of photosensitive resistor, thus completing the process of converting optical signal into electrical signal, the electrical signal is voltage at both ends of photoresistor.

Microcontroller mentioned in S4 receives and processes electrical signals and in step S5 outputs purification force of filter, microcontroller adopts STM32 system board to receive and process electrical signals output by photosensitive module, then output

filter purification force and filter replacement alarm signal. Its logical condition is: when cumulative purification amount of filter particles does not exceed the upper limit of cumulative purification amount of particulate matter stipulated by the national standards of air purifiers, filter purification force will be displayed, and no replacement alarm will be given; when cumulative purification amount of filter particles exceeds the upper limit of cumulative purification amount of particulate matter stipulated by the national standards of air purifiers, filter purification force will be displayed and indicator light is used to replace alarm.

S6 shows the filter purification force: when cumulative purification amount of filter particles does not exceed the upper limit of cumulative purification amount of particulate matter stipulated by the national standards of air purifiers, filter purification force is displayed in the form of percentage and the filter does not need to be replaced; when cumulative purification amount of particles exceeds the upper limit of cumulative purification amount of particles stipulated by the national standards of air purifiers, purification force is displayed and send an alarm signal to replace the filter.

The above embodiments are only used to describe the invention and are not used to limit the invention. Although embodiments of the invention have been described, ordinary technicians in the field may vary, modify, replace and deform such embodiments without breaking away from the principles and spirit of the invention, and scope of the invention is limited by the attached claims and their equivalents.

What is claimed is:

1. Alarm device for household air purifier filter replacement based on photoresistor comprising: a light transmitter, a light receiver and a microcontroller which are successively connected, wherein the microcontroller connects with a display module and an alarm module respectively; wherein the light transmitter emits visible light on one side of a filter of a purifier, the light receiver receives the visible light emitted from the light transmitter on the other side of the filter and converts an illuminance signal into an electrical signal and sends the electrical signal to the microcontroller; the microcontroller is used to receive the electrical signal and output a purification force of the filter and output an alarm signal of filter replacement; the display module is used to display the purification force of the filter; the alarm module is used to remind a user to replace the filter according to the alarm signal.

2. The alarm device for household air purifier filter replacement based on photoresistor according to claim 1, wherein the light transmitter uses 1 W LED with white light.

3. The alarm device for household air purifier filter replacement based on photoresistor according to claim 1, wherein the light receiver adopts photosensitive resistor module sensor which is sensitive to visible light and converts illuminance signal inside the filter into voltage value electrical signal and sends the voltage value electrical signal to the microcontroller.

4. The alarm device for household air purifier filter replacement based on photoresistor according to claim 1, wherein the display module adopts LCD.

5. The alarm device for household air purifier filter replacement based on photoresistor according to claim 1, wherein the alarm module adopts indicator light.
